(19) United States
(12) Patent Application Publication
(10) Pub. No.: US 2018/0205924 A1
(43) Pub. Date: Jul. 19, 2018

(54) DISPLAY ASSEMBLY AND ELECTRONIC DISPLAY APPARATUS FOR THE APPLICATION THEREOF

(71) Applicant: YI LE, SHANGHAI (CN)

(72) Inventors: QINGHUA ZHENG, MUNICH (DE); ALLEN YEN, SCHNECKSVILLE, PA (US)

(73) Assignee: YI LE, SHANGHAI (CN)

(21) Appl. No.: 15/410,100

(22) Filed: Jan. 19, 2017

(51) Int. Cl. H04N 13/00; G02B 27/22; G09G 3/00; H04N 13/04

(52) U.S. Cl. CPC H04N 13/0011; G02B 27/2235; H04N 13/0404; H04N 13/0459; G09G 3/003

(57) ABSTRACT

Disclosed is a display assembly and an electronic display apparatus for the application thereof, wherein the display assembly is disposed at a light-emitting surface side of a display device, a local light field corresponding to each pixel point one by one is formed among the display assembly and pixel points on the display device; display information of a target object to be displayed at each view angle corresponding to each pixel point respectively is outputted through each local light field to form a 3D display picture of the target object to be displayed at different view angles and thus form an interactive 3D display effect, thereby greatly enhancing the entertainment; the present invention has the advantages of a simple structure, easy realization, low cost, a wide range of application and high commercial value.

### TECHNICAL FIELD OF THE INVENTION

The present invention relates to the field of display technology, particularly to a display assembly and an electronic display apparatus for the application thereof.

### TECHNICAL BACKGROUND OF THE INVENTION

Currently, most of display technologies are 2D, 2D print media are for example: a print publication, a photograph, a display, or the like, they have the advantages of cheapness and convenience, but have the disadvantage that they are only 2D and hence cannot meet entertainment needs of modern people for a sense of reality.

Therefore, a number of 3D display technologies have emerged, such as a common 3D movie, its principle is mainly to receive different images via two eyes respectively by using color difference glasses, polarized glasses or liquid crystal shutter glasses, for example, the left eye receives vertically polarized light of an image while the right eye receives horizontally polarized light of the image, and the like, that is, double-picture technology is used to form a 3D perception. However, although a 3D display effect is formed, the disadvantages lie in inconvenient use and the use of glasses, as there is only a fixed perspective, there is still the same picture from a different point of view, and hence there is no sense of space interaction.

### SUMMARY OF THE INVENTION

In view of the drawbacks of the prior art described above, an objective of the present invention is to provide a display assembly and a display device to solve the above-mentioned problems in the 3D display technologies in the prior art.

To realize the above objective and other related objectives, the present invention provides a display assembly which is disposed at a light-emitting surface side of a display device, a local light field corresponding to each pixel point one by one is formed among the display assembly and the pixel points on the display device; display information of a target object to be displayed at each view angle corresponding to each pixel point respectively is outputted through each local light field to form a 3D display picture of the target object to be displayed at different view angles.

Preferably, the display information corresponding to the target object to be displayed at each view angle comprises: a coordinate information of a plane where each pixel point is located, an angle between each light-emitting ray of the pixel point at different view angle and the plane, an angle between each light-emitting ray and a orthogonal direction of the plane, as well as color and luminance information of each pixel point.

Preferably, the display assembly is a lens group.

Preferably, the display assembly is a curved-surface-shaped convex lens array.

Preferably, the display assembly is a mirror group.

Preferably, the display assembly is a curved-surface-shaped concave mirror array.

Preferably, the display device comprises a LCD display screen, a TFT-LCD display screen, a SED display screen, a LED display screen or an OLED display screen.

Preferably, the display device and the display assembly are an integrally formed display screen.

Preferably, the display device comprises a curtain having light emitting and a pattern to be displayed.

To realize the above objective and other related objectives, the present invention provides an electronic display assembly, comprising the abovementioned display assembly and the display device.

Preferably, the electronic display apparatus comprises any one of an electronic display screen, a television, a computer display, a mobile phone and a tablet computer.

To realize the above objective and other related objectives, the present invention provides a vertical display device comprising a vertical display screen; the abovementioned display assembly is disposed at a light-emitting surface side of the vertical display screen and under the state of reflecting the light emitting downwards.

To realize the above objective and other related objectives, the present invention provides a display system, comprising a plurality of the display assemblies and a plurality of the display devices mentioned above; each display assembly is disposed correspondingly at the light-emitting surface side of the plurality of the display devices respectively; wherein the plurality of the display devices are spliced and combined to display a 3D display picture of the same target object to be displayed at different view angles.

As mentioned above, the present invention provides the display assembly and the electronic display apparatus for the application thereof, the display assembly is disposed at the light-emitting surface side of the display device, the local light field corresponding to each pixel point is formed one by one among the display assembly and the pixel points on display device; display information of the target object to be displayed at each view angle corresponding to each pixel point respectively is outputted through each local light field to form the 3D display picture of the target object to be displayed at different view angles and thus form an interactive 3D display effect, thereby greatly enhancing the entertainment; the present invention has the advantages of a simple structure, easy realization, low cost, a wide range of application and high commercial value.

### DRAWINGS OF THE INVENTION

FIG. 1 shows a principle diagram of a light field of the present invention.

FIGS. 2a-2c show structural diagrams of an application embodiment of the present invention.

FIG. 3 shows a structural diagram of an application embodiment of the present invention.

FIGS. 4a-4e show structural diagrams of an application embodiment of a display assembly of the present invention.

FIG. 5 shows a structural diagram of an application embodiment of the present invention.

FIG. 6 shows a structural diagram of an application embodiment of the present invention.

### DESCRIPTION OF REFERENCE NUMERALS

1 Target object

2 Display plane

21 Pixel point

211 Direction vertical to a display plane

3 Display device

31 Pixel point

4, 4′ Display assembly

41 Lens

41′ Mirror

5 Vertical display screen

51 Pixel point

### Embodiments of the Invention

An embodiment of the present invention will now be described by way of specific examples, and other advantages and efficacies of the present invention will be readily apparent to one skilled in the art from the disclosure of this specification. The present invention may also be practiced or applied through other different specific embodiments, the various details in this specification may also be based on various points of view and applications to make various modifications and changes without departing from the spirit of the invention. It should be noted that in the case of no conflict, the embodiments of the present application and features of the embodiments may be combined with each other.

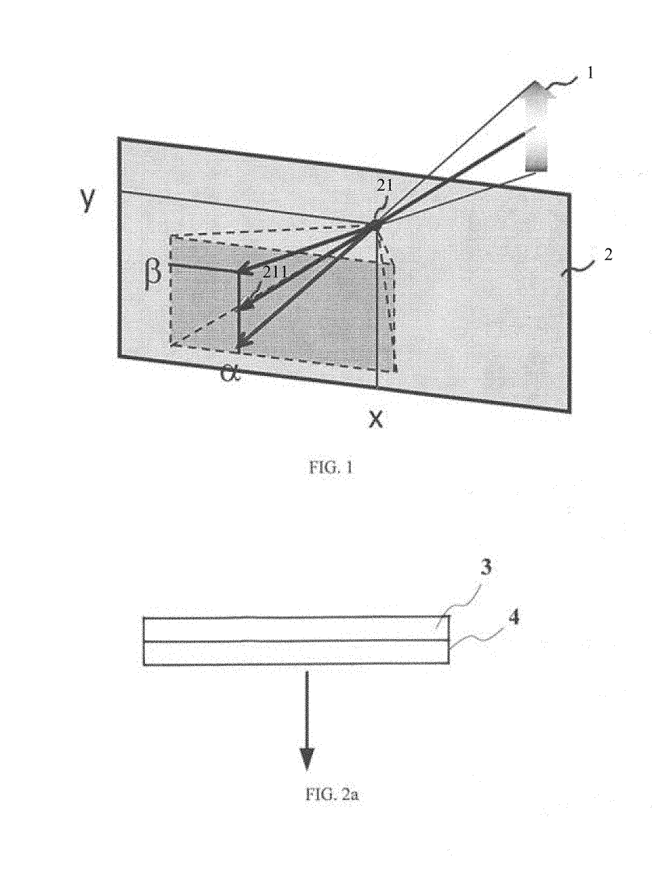

As shown in FIG. 1, one inventive point of the present invention is the use of a light field, in an example, the light field may be defined as LF (x, y, α, β), wherein a target object 1 (which may be a 3D object) to be displayed is firstly assumed, a point, which is on the target object 1, is projected on a display surface 2 as a pixel point 21 for displaying, a coordinate of the pixel point 21 is labeled as (x, y), the α and β represent two included angles of a light ray emitted by the pixel point 21 relative to a direction for example a direction 211 perpendicular to the display plane and relative to x direction and y direction respectively. By this setting, angle information of each light ray emitted by the pixel point 21 can be defined, so that display information of the light ray emitted by each pixel point 21 at each angle can be defined to constitute the light field. Display information corresponding to the target object 1 to be displayed at each view angle comprises: coordinate information of a plane where each pixel point 21 is located, an angle between each light-emitting ray of each pixel point 21 at each view angle and the plane, an angle between each light-emitting ray and the orthogonal direction of the plane, as well as color (colors RGB) and luminance information of each pixel point 21, therefore, various information of each point on the target object 1 to be displayed can be visually fed back at each view angle, so that a true interactive 3D effect can be achieved.

It should be noted that, although the definition of the light field itself is a mature theory and concept, the main improvement of the present invention is the use of the light field for display technology, the specific use will be described in detail hereinafter.

Here, for convenience of description, the target object 1 to be displayed is presumed to be behind the display plane 2 (i.e., the target object 1 is separated from naked eyes by the display plane 2) or also certainly be displayed in front of the display plane 2, which can be realized by optical transmission, refraction, reflection or other manners, in fact, from the plane point of view, without a reference object, the naked eyes can not tell whether an imaging is in front of or behind the display plane 2.

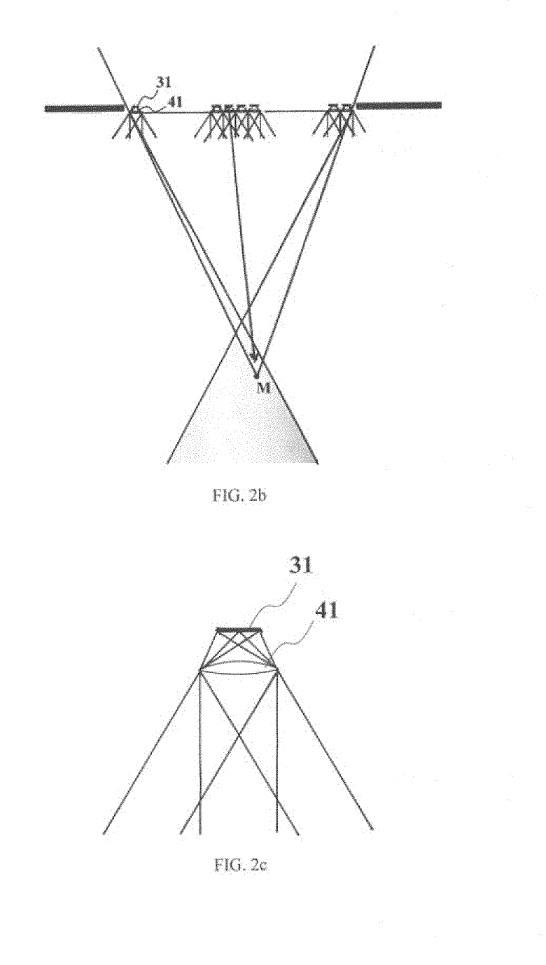

As shown in FIGS. 2a to 2c, in one embodiment, the display plane 2 may be a light-emitting surface of a display device 3. As shown in FIG. 2a, the present invention provides a display assembly 4, the display assembly 4 is disposed at the light-emitting surface side of the display device 3 with a light-emitting direction indicated by an arrow in the drawing, one-to-one correspondence local light fields are formed among the display assembly 4 and pixel points 31 on the display device 3. With reference to FIGS. 2b-2c, where FIG. 2c is a partial enlarged figure of FIG. 2b, the light emitting surface of the display device 31 is covered by a plurality of the local light fields, each corresponding pixel 31 is to establish a local light field to record the information of the light ray of the pixel point at each angle. In the present embodiment, each pixel has its own coordinate (x, y), and each light ray has its own angle information (α, β) in the local light field, therefore, display information of each pixel point corresponding to the target object to be displayed at each view angle is outputted through each local light field, to form a 3D display picture of the target object to be displayed at different view angles. In the present embodiment, as shown in FIG. 2b, the display assembly 4 is a lens group, the lenses 41 one-to-one corresponds to the pixel point 31 to form local light fields. A gray area is an observation area, wherein the observation point is, for example, the point M illustrated, however, the other opposite side taking the display device 31 as a reference is a target area of the target object to be displayed. Of course, the display assembly 4 is the lens group, which is only an example but is not limited to this example, the similar effect can be achieved by using a mirror group.

In other words, the target object is a display content of a 3D picture to be displayed by the display device, such as an apple, a house, a person, a scene, or other various artificially formed images. In order to allow the 3D display picture corresponding to the target object to be visually obtained, a plurality of the local light fields are constituted by the display device 3 and the display assembly 4 in advance, furthermore, each of the local light fields is capable of feeding back to the naked eyes the display information corresponding to each point (for example, the pixel point) of the 3D display picture to be displayed at each angle. In this embodiment, the display device may be electronic display screens of LCD, TFT-LCD, SED, LED, OLED and the like. As described above, the display assembly 4 is the lens group, and preferably may be a curved-surface-shaped lens array, the display assembly 4 may for example be a MEMS processed and a form of a film made of a polymer material, an optical glass material or other materials to be attached to the light-emitting surface of the display device 3, the display device 3 is still the electronic display screen and the like in prior art, therefore, 3D display remake of an electronic display apparatus in the prior art, such as a mobile phone, a tablet computer and the like, may be completed by one layer of the display assembly 4, the commercial value is very high.

It should be noted that, in another embodiment, the display assembly and the display device are formed integrally, that is, the display device is taken as a whole product.

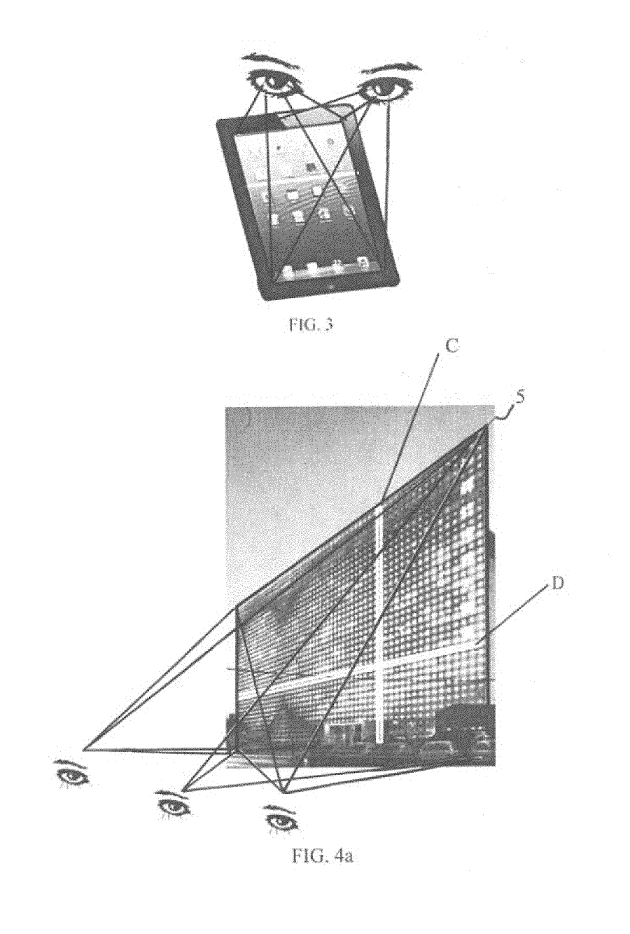

As shown in FIG. 3, according to the application of the display assembly 4 in the above embodiment, the present invention may further provide an electronic display apparatus comprising the display assembly and the display device as described above, the display assembly is disposed at the light-emitting surface side of the display device, wherein the electronic display apparatus comprises one or more of an electronic display screen (for example, the display screen produced as an electronic product component, for example, LCD, TFT-LCD, SED, LED, OLED manufacture procedures and other manufacture procedures), a television, a display, a mobile phone, a tablet computer and the like. If the display assembly and the display device are separated, the display assembly is used as, for example, a film, when Apple, Samsung, HTC and other brands of mobile phones or Tablet PC are used, the 3D display remake of the electronic display apparatus may be completed by the application of the display assembly; if the two are integral, they can be used as a whole display.

Of course, it should be noted that the display device further comprises a curtain having light emitting and a pattern to be displayed. Information of the light field corresponding to the pattern to be displayed (i.e., a set of angle information of the light-emitting ray at each point on the pattern to be displayed, RGB information, luminance information and the like) is displayed by the light emission of the curtain to further show the 3D display effect of the pattern to be displayed through the display assembly. That is, the present invention may also be applied to the field of non-electronic display, in addition to the above-mentioned electronic display field. The curtain may be, for example, a projection white cloth, although there is no direct light emission, it is possible to utilize reflection light, or for example, an advertising cloth in an advertising light box, which uses backlight to emit light, and the like. On basis of these, the 3D display effect can be realized by applying the design of the present invention.

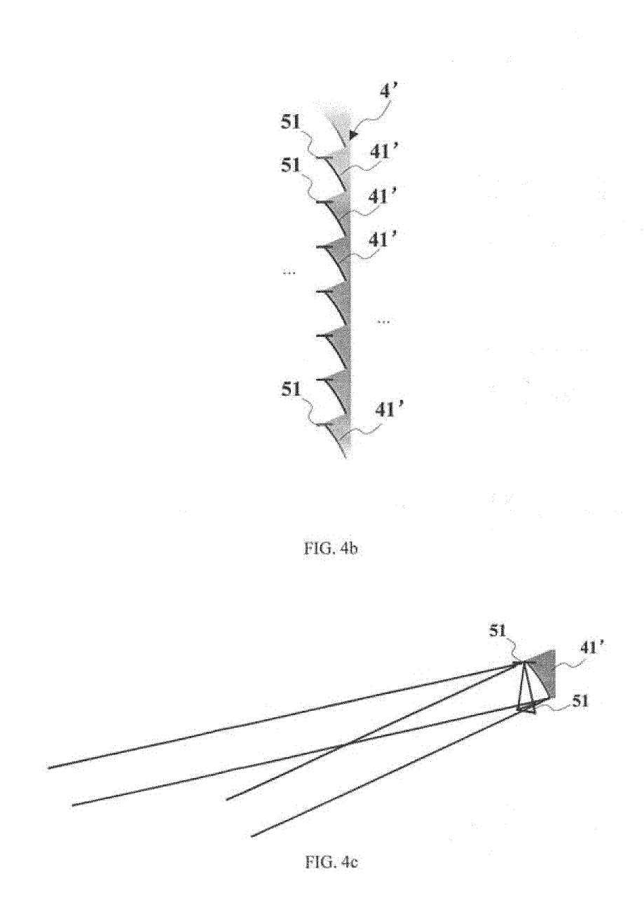

As shown in FIGS. 4a-4e, FIG. 4b is a partial structural diagram of a side view of area C of FIG. 4a, FIG. 4c is a principle diagram of a partially amplified light field of FIG. 4b; FIG. 4d is a partial structural diagram of area D of FIG. 4a viewed from the front, FIG. 4e is a principle diagram of a partially amplified light field in FIG. 4d; in this embodiment, the present invention may also provide a vertical display device comprising a vertical display screen 5, which may consist of a plurality of pixel points 51; herein, the display assembly 4′ is a mirror group disposed at the light-emitting surface side of the vertical display screen 5, and under the state of reflecting the light emitting downwards. This vertical display device is suitable for a large billboard or a high-altitude hanging billboard and other environments. Since the object to be displayed is much higher than the naked eyes, reference is made to FIG. 4b by establishing the light field between each of the mirrors 41′ in the mirror group and the pixel points 51 of the vertical display screen 5 to reflect downwards to the naked eyes the light ray of each pixel point of the vertical display screen 5 comprising color and brightness at each angle, so as to achieve an objective of providing the people below with the 3D display effect, wherein, preferably, as shown in FIG. 4b, viewed from one side, the mirrors 41′ may be vertically arrayed from the top to the bottom and each mirror 41′ may have an obliquely downward reflecting surface, the plurality of the pixel points 51 may be vertically arrayed from the top to the bottom in one-to-one correspondence with the mirrors, the light-emitting surface thereof faces a reflecting surface to complete the downward display of the light ray by reflection. As shown in FIG. 4c, viewed from the front, it is similar to the above, therefore, the mirror 41′ may be a curved-surface-shaped mirror, the display assembly is a curved-surface-shaped mirror array. Of course, since the large-sized vertical display screen 5 is formed in a combination of blocks, it is preferable that the mirror group and the vertical display screen 5 are partitioned and mounted correspondingly.

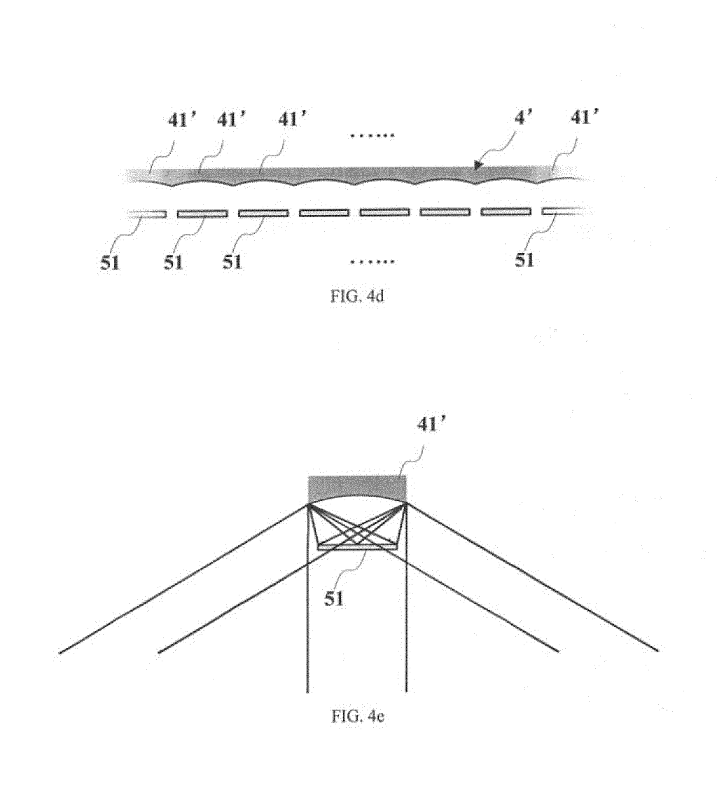

Referring again to FIG. 5, according to the display device applied with the display assembly or an integrally formed design of the display device and the display assembly in the above embodiments—the present invention provides a display system comprising a plurality of the display devices, which are spliced and combined to display the 3D display picture of the same object to be displayed at different view angles, each display device is responsible for displaying a different part of the same 3D display picture or a part from a different angle, and the parts can be synchronized therebetween to dynamically change. In this embodiment, five display devices are placed in the upper, front, rear, left and right directions so that the 3D display effect can be given to a viewer in all directions. However, this is only an example, in other embodiments, there may be six display devices, seven display devices or the like, the display device may be an arc or other shapes, one skilled in the art can change them with the particular application environment, rather than the present embodiment.

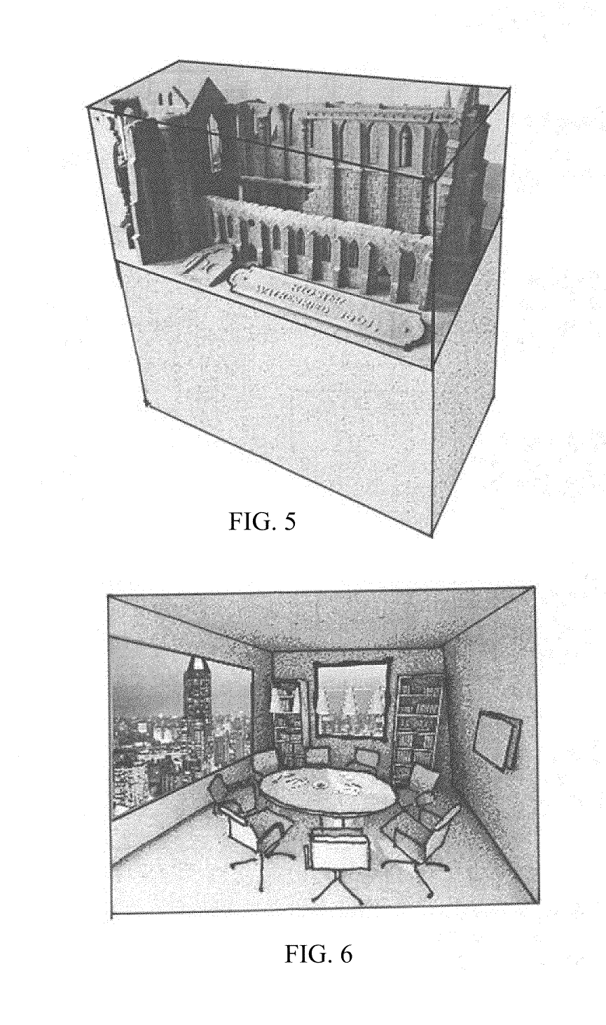

As shown in FIG. 6, in still another embodiment, the present invention can also be applied to indoor environments such as a home, a shopping mall, a cafe, and other places, the display device applied with the display assembly or an integrally formed design of the display device and the display assembly according to the present invention, for example, a television, the display, etc., may be mounted on a wall surface, to create a virtual display scene, that is, it may be used as a window, the object to be displayed is displayed as a scene outside the window, for example, a user can play the sceneries across the world in the room to create a sense of entertainment of space transfer, a display content thereof is such as a city landscape shown in the drawing, scenic spots and so on.

In summary, the present invention provides a display assembly and an electronic display apparatus for the application thereof, the display assembly is disposed at a light-emitting surface side of a display device, a local light field corresponding to each pixel point one by one is formed among the display device and the pixel points on the display assembly; display information of an object to be displayed at each view angle corresponding to each pixel point respectively is outputted through each local light field to form a 3D display picture of the object to be displayed at different view angles, and thus form an interactive 3D display effect, thereby greatly enhancing the entertainment; the present invention has the advantages of a simple structure, easy realization, low cost, a wide range of application and high commercial value.

The foregoing examples illustrate only the principle of the present invention and the efficacy thereof, and are not intended to limit the present invention. It will be apparent to one skilled in the art that various modifications and variations may be made in the above-described embodiments without departing from the spirit and scope of the present invention. Accordingly, it is intended that the appended claims cover all equivalent modifications and variations made by one skilled in the art to which the invention pertains without departing from the spirit and technical idea of the present invention.

1. A display assembly, wherein the display assembly is disposed at a light-emitting surface side of a display device, a local light field corresponding to each pixel point one by one is formed among the display assembly and the pixel points on the display device;
display information of a target object to be displayed at each view angle corresponding to each pixel point respectively is outputted through each local light field to form a 3D display picture of the target object to be displayed at different view angles.

2. The display assembly of claim 1, wherein the display information corresponding to the target object to be displayed at each view angle comprises: coordinate information of a plane where each pixel point is located, an angle between each light-emitting ray of the pixel point at different view angle and the plane, an angle between each light-emitting ray and a orthogonal direction of the plane, as well as color and luminance information of each pixel point.

3. The display assembly of claim 1, wherein the display assembly is a lens group.

4. The display assembly of claim 3, wherein the display assembly is a curved-surface-shaped convex lens array.

5. The display assembly of claim 1, wherein the display assembly is a mirror group.

6. The display assembly of claim 5, wherein the display assembly is a curved-surface-shaped concave mirror array.

7. The display assembly of claim 1, wherein the display device comprises a LCD, TFT-LCD, SED, LED or OLED processing electronic display screen.

8. The display assembly of claim 7, wherein the display device and the display assembly are an integrally formed display screen.

9. The display assembly of claim 1, wherein the display device comprises a curtain having light emitting and a pattern to be displayed.

10. An electronic display apparatus, comprising the display assembly and the display device according to claim 1.

11. The electronic display apparatus of claim 10, wherein the electronic display apparatus comprises any one of an electronic display screen, a television, a display, a mobile phone and a tablet computer.

12. A vertical display device, comprising a vertical display screen and the display assembly according to claim 5, the display assembly is disposed at a light-emitting surface side of the vertical display screen and under the state of reflecting the light emitting downwards.

13. A display system, comprising a plurality of display assemblies and a plurality of display devices according to claim 1, each display assembly is disposed correspondingly at a light-emitting surface side of the plurality of the display devices respectively; wherein the plurality of the display devices are spliced and combined to display a 3D display picture of the same target object to be displayed at different view angles.
